(19) United States
(12) Patent Application Publication
(10) Pub. No.: US 2012/0175965 A1
(43) Pub. Date: Jul. 12, 2012

(54) System and Method for Reducing Mismatch in a Photovoltaic Structure

(76) Inventors: Mohamed Zakaria Mohamed Ahmed SHAMSELDEIN, Waterloo (CA); Mehrdad Kazerani, Waterloo (CA); Magdy Salama, Kitchener (CA)

(21) Appl. No.: 13/354,622

(22) Filed: Jan. 20, 2012

Related U.S. Application Data
(63) Continuation of application No. PCT/CA2011/000556, filed on May 17, 2011.
(60) Provisional application No. 61/345,179, filed on May 17, 2010.

(51) Int. Cl. H02J 1/00

(52) U.S. Cl. 307/86

(57) ABSTRACT

A photovoltaic structure having a reduced mismatch, and a system, method and computer program for reducing mismatch in a photovoltaic structure are provided. The photovoltaic structure has a plurality of photovoltaic elements arranged in a plurality of rows and a plurality of columns. The photovoltaic elements are electrically connected to one another in a plurality of parallel circuits connected together. At least two of the photovoltaic elements from one of the rows are connected in different parallel circuits to reduce partial shading loss for a plurality of time instants. The system, method and computer program provide a connection matrix for the photovoltaic structure based on irradiance levels for the photovoltaic elements to enable connection of the photovoltaic elements to one another to reduce partial shading loss for a plurality of time instants.

### PRIORITY CLAIM

This application is a continuation of PCT Patent Application No. PCT/CA2011/000556, filed May 17, 2011, which claims priority from U.S. Provisional Patent Application No. 61/345,179 filed May 17, 2010, both of which are incorporated herein by reference.

### FIELD OF THE INVENTION

The present invention relates generally to reducing mismatch in a photovoltaic structure.

### DESCRIPTION OF THE PRIOR ART

Increase in oil prices, depletion of fossil fuel reservoirs, energy security concerns and global warming have been the most important motives behind the use of renewable energy for power generation, including solar energy. Energy from solar can be generated using photovoltaic (PV) structures. PV structures are expected to play a major role in smart grids as a distributed generation or as a power plant.

The use of PV structures for power generation brings many challenges, one of which is partial shading loss. Partial shading loss occurs when a part of a PV structure is shaded by a shading source. These sources could be predictable sources such as nearby structures, trees and arrays or unpredictable sources such as clouds, dust and snow. For example, it has been shown that a neighbouring building, tree or passing clouds can cause a PV structure to have an annual loss up to 10%

A PV structure comprises a plurality of PV elements such as cells, modules, panels, arrays, farm fields and farms. Partial shading causes the output of even the unshaded parts of the PV structure to decrease since a partially shaded PV structure has a mismatch between its constituent PV elements. When the PV elements are connected in what is referred to as series-parallel connection, the mismatch in the I-V characteristics of the series PV elements causes reduction in the generated power and hot spots. A total-cross-tied connection can reduce the effect of mismatch by first connecting the elements in the same physical row in parallel and then connecting all the rows in series, forming one column. This style of connection reduces the overall effect of mismatch in the PV system but is still affected by partial shading loss.

Hot spots can also be eliminated using bypass diodes. However, these diodes create multiple power peaks which increase the complexity of the Maximum Power Point Tracking (MPPT). The increased complexity of MPPT may lead to an operation that is not optimized at the maximum power point. Thus, the power generated by a system cad be reduced significantly. Bypass diodes, furthermore, do not solve the problem of reduction in generated power.

Reconfigurable PV arrays have been proposed to increase the generated power under partial shading conditions. These arrays use switches, sensors and controllers to increase the generated power with the side effect of increase in the complexity of the PV structure.

The effects of partial shading from neighbouring arrays could be reduced by increasing the PV system farm area. However, partial shading losses from unpredictable sources are difficult to reduce.

It is therefore an object of the present invention to obviate or mitigate the above disadvantages.

### SUMMARY OF THE INVENTION

In one aspect, a photovoltaic structure is provided, said photovoltaic structure characterized by a plurality of photovoltaic elements arranged in a plurality of rows and a plurality of columns, said photovoltaic elements electrically connected to one another in a plurality of parallel circuits connected together, wherein at least two of said photovoltaic elements from one of said rows are connected in different parallel circuits to reduce mismatch in the photovoltaic structure for a plurality of time instants.

In another aspect, a system for reducing mismatch in a photovoltaic structure is provided, said photovoltaic structure comprising a plurality of photovoltaic elements arranged in a plurality of rows and a plurality of columns, said system characterized by a partial shading loss reduction engine operable to provide a connection matrix for said photovoltaic structure based on irradiance levels for said photovoltaic elements, said connection matrix enabling connection of said photovoltaic elements to one another in a plurality of parallel circuits connected together to reduce mismatch for a plurality of time instants.

In a further aspect, a method for reducing mismatch in a photovoltaic structure is provided, said photovoltaic structure comprising a plurality of photovoltaic elements arranged in a plurality of rows and a plurality of columns, said method characterized by providing a connection matrix for said photovoltaic structure based on irradiance levels for said photovoltaic elements, said connection matrix enabling connection of said photovoltaic elements to one another in a plurality of parallel circuits connected together to reduce mismatch for a plurality of time instants.

In an additional aspect, a computer program product for reducing mismatch in a photovoltaic structure is provided, said photovoltaic structure comprising a plurality of photovoltaic elements arranged in a plurality of rows and a plurality of columns, said computer program product comprising a computer readable medium having stored thereon computer executable instructions which when executed by a computer processor are operable to provide a connection matrix for said photovoltaic structure based on irradiance levels for said photovoltaic elements, said connection matrix enabling connection of said photovoltaic elements to one another in a plurality of parallel circuits connected together to reduce mismatch for a plurality of time instants.

### BRIEF DESCRIPTION OF THE DRAWINGS

The features of the invention will become more apparent in the following detailed description in which reference is made to the appended drawings wherein:

FIG. 1 is a block diagram of a system in accordance with an aspect of the present invention;

FIG. 2 is a schematic representation of an example of a total-cross-tied PV structure and a PV structure connected in accordance with the present invention;

FIG. 3 is a schematic representation of another example of a PV structure connected in accordance with the present invention;

FIG. 4 is a schematic representation of an equivalent circuit of a PV element;

FIG. 5 is a block diagram illustrating irradiance levels of PV elements arranged on a PV structure;

FIG. 6 is a graphical illustration of a comparison of P-V characteristics of a series-parallel PV structure, a total-cross-tied PV structure and a PV structure connected in accordance with the present invention for no partial shading;

FIG. 7 is a block diagram illustrating three sets of irradiance levels of PV elements arranged on a PV structure under three partial shading conditions;

FIG. 8 is a schematic representation of an example of a total-cross-tied PV structure and a PV structure connected in accordance with the present invention based on the partial shading conditions shown in FIG. 7;

FIG. 9 is a graphical illustration of a comparison of P-V characteristics of a series-parallel PV structure, total-cross-tied PV structure and a PV structure connected in accordance with the present invention for a first partial shading condition;

FIG. 10 is a graphical illustration of a comparison of P-V characteristics of a series-parallel PV structure, total-cross-tied PV structure and a PV structure connected in accordance with the present invention for a second partial shading condition; and

FIG. 11 is a graphical illustration of a comparison of P-V characteristics of a series-parallel PV structure, total-cross-tied PV structure and a PV structure connected in accordance with the present invention for a third partial shading condition.

### DETAILED DESCRIPTION OF THE INVENTION

The present invention provides a system, method and computer program for reducing mismatch in a PV structure.

The present invention also provides a PV structure that is configured to reduce mismatch. More particularly, the PV structure described herein is configured to exhibit less mismatch than a substantially similar PV structure that is configured in a typical total-cross-tied circuit.

It has been found that partial shading is one cause of mismatch. It shall, therefore, be appreciated that while the following description discusses reducing partial shading loss, the systems, methods and computer programs described herein are also applicable to reducing mismatch in PV structures generally.

A PV structure as described herein comprises a plurality of PV elements. The PV elements could be PV cells, PV modules, PV panels, PV arrays, PV farm fields, PV farms, or any combination thereof. A typical PV structure includes a plurality of PV elements that are physically arranged in a plurality of rows and a plurality of columns. For example, a particular PV panel comprises a grid of PV modules, where the grid includes m rows and n columns.

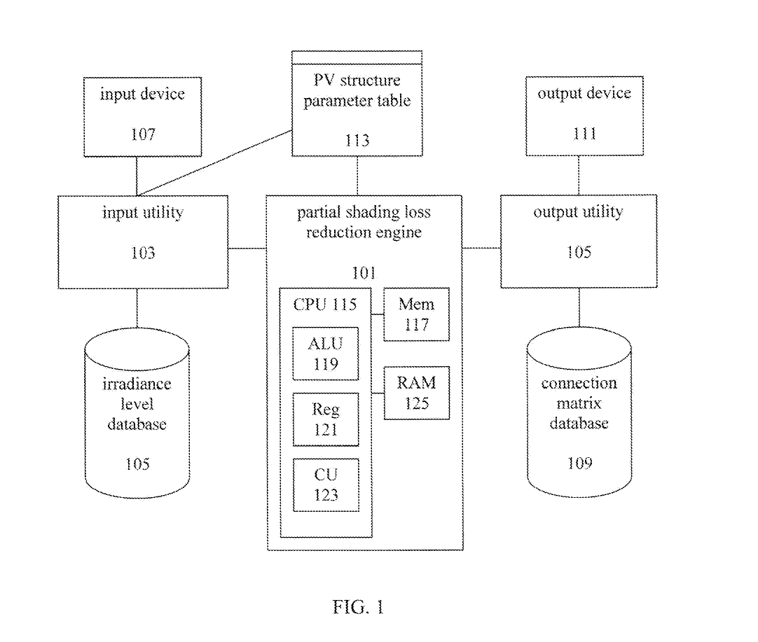

Referring therefore to FIG. 1, a system in accordance with the present invention comprises a partial shading loss reduction engine 101 and may further comprise an input utility 103 linked to an irradiance level database 105, an input device 107, or both; an output utility 105 linked to a connection matrix database 109, an output device 111 or both; and a PV structure parameter table 113. The input utility 103 is configured to provide input to the partial shading loss reduction engine 101 and the output utility 105 is configured to receive output from the partial shading loss reduction engine 101. The input device 107 may include a keyboard, touch screen or other similar device. The output device 111 may include a monitor, printer or other device operable to provide output to a user.

The partial shading loss reduction engine 101 is operable to determine a circuit arrangement for the PV elements of a PV structure to reduce partial shading loss by reducing the effects of mismatch between PV elements that is optimized for one or more time segments. The mismatch is based on different irradiance levels experienced by at least two of the PV elements. These irradiance levels may be observed or predicted.

Each time segment comprises one or more time instant: Each time segment may be associated with different partial shading conditions than the remaining time segments. The partial shading loss reduction engine 101 provides a circuit arrangement for a PV structure that will have an overall reduced partial shading loss over all the time segments and may have a reduced partial shading loss individually for one or more of the time segments.

The PV structure parameter table 113 comprises parameters for the PV structure, including, for example, a reference irradiance level, element short circuit current at the reference irradiance level, reverse bias diode saturation current, number of series cells in the element, element series resistance, element thermal voltage, and element parallel resistance. The PV structure parameter table 113 can be input through the input utility 103 or provided as a preconfigured table to the partial shading loss reduction engine 101.

The partial shading loss reduction engine 101 may be implemented by a set of computer instructions stored on a storage medium 117, such as a memory, which when executed by a computer processor 115 are operable to provide the functionality described herein. In this regard, the computer processor 115 may comprise an arithmetic logic unit 119, registers 121, and control unit 123. The computer processor may further be interact with additional systems such as a volatile store 125 such as a Random Access Memory (RAM). Those skilled in the art will appreciate that portions of the instructions implementing the partial shading loss reduction engine may be temporarily loaded into the volatile store to facilitate faster execution.

The partial shading loss reduction engine is operable to provide a connection matrix for a PV structure based on irradiance levels for PV elements in the PV structure. The irradiance levels may be obtained from historical observed irradiance levels or predicted irradiance levels, corresponding to a particular installation site for the PV structure, that are recorded on the irradiance level database 105. The irradiance levels could also be provided by a user by inputting the irradiance levels using the input device 107. The connection matrix can be recorded on the connection matrix database 109 and could also be output to the output device 111.

The provided connection matrix enables connection of the PV elements to one another in a plurality of parallel circuits connected together. For example, the connection matrix may comprise rows and columns that correspond to a schematic representation of the circuit. For example, PV elements appearing in a particular row of the connection matrix are to be connected in parallel, and each of the rows is to be connected in series.

The reduction in partial shading loss can be observed relative to a total cross tied configuration.

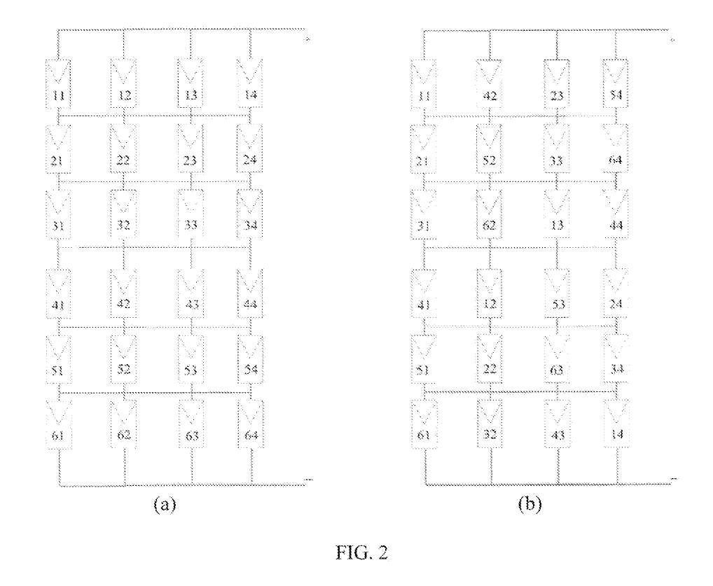

Referring therefore to FIG. 2a, a typical total-cross-tied PV structure is shown in accordance with its circuit arrangement. The physical location of each PV element in the PV structure is denoted by a reference numeral that is its row number followed by column number (i.e., PV element 13 is physically located at row 1, column 3 of the PV structure). A typical total-cross-tied PV structure connects each PV element in a particular row in parallel. Each of these parallel circuits are then connected together in series, as shown.

Based on observation or prediction of sources of partial shading loss, it has been found that partial shading loss can be reduced by connecting the PV elements to one another in accordance with the fact that adjacent PV elements are more likely to be shaded simultaneously than elements placed further from one another. It has been found that it is possible to reduce the overall mismatch between the PV elements during partial shading to increase the generated power of the PV system by connecting at least a subset of the PV elements from different rows in parallel and then connecting the rows in series to form one column. Connecting the shaded PV elements in different parallel circuits may result in more uniform distribution of irradiance levels that may reduce partial shading losses. The resulting arrangement may also have fewer power peaks than are created using bypass diodes. The resulting arrangement can be considered as a modification to the total-cross-tied connection.

Referring therefore to FIG. 2b, an example of a PV structure having a circuit arrangement in accordance with the present invention is shown. Again, the physical location of each PV element in the PV structure is denoted by a reference numeral that is its row number followed by its column number. In this example, one parallel circuit is comprised of PV elements 11, 42, 23 and 54 from (1, 1), (4, 2), (2, 3) and (5, 4), respectively; another parallel circuit is comprised of PV elements 21, 52, 33 and 64 from (2, 1), (5, 2), (3, 3) and (6, 4), respectively; another parallel circuit is comprised of PV elements 31, 62, 13 and 44 from (3, 1), (6, 2), (1, 3) and (4, 4), respectively; another parallel circuit is comprised of PV elements 41, 12, 53 and 24 from (4, 1), (1, 2), (5, 3) and (2, 4), respectively; another parallel circuit is comprised of PV elements 51, 22, 62 and 34 from (5, 1), (2, 2), (6, 3) and (3, 4), respectively; and another parallel circuit is comprised of PV elements 61, 32, 43 and 14 from (6, 1), (3, 2), (4, 3) and (1, 4), respectively.

In accordance with the present invention, the circuit arrangement does not require all PV elements from any particular row to be connected in parallel. Rather, in accordance with the system and method described herein, at least one of the PV elements can be connected in parallel with at least one PV element from a different physical row in the PV structure. Thus, at least two PV elements from one of the physical rows can be connected in different parallel circuits. These two PV elements could, for example, be adjacent PV elements from a particular row. It should be understood that the PV structure shown is one example only, and that different circuit arrangements may be provided based on particular irradiance levels.

The partial shading loss reduction engine 101 executes an energy maximizing algorithm or a mismatch reducing algorithm for a particular PV structure to generate the connection matrix. The PV structure may comprise a plurality of PV elements where a subset of the PV elements are reconfigurable. The reconfigurable PV elements can be connected in a parallel circuit that is different from the parallel circuit in which another PV element from the same row is connected. Each reconfigurable PV element is connectable to at least two of the parallel circuits and preferably is connectable to any of the parallel circuits.

The subset of PV elements that are reconfigurable can be as few as two PV elements and as many as all the PV elements. Preferably, there are at least m reconfigurable PV elements where m is the number of rows in the PV structure.

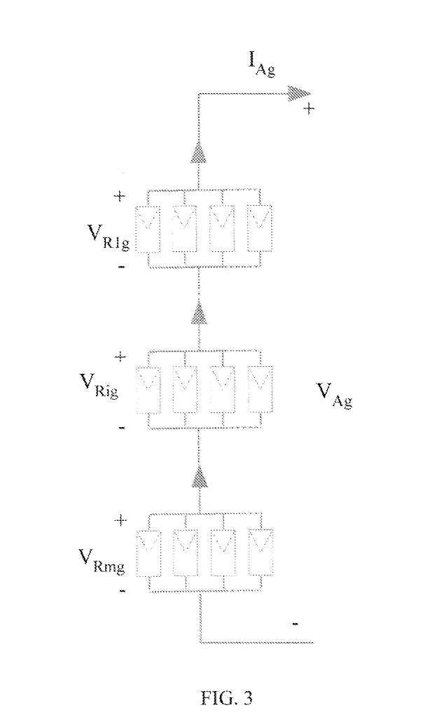

Referring now to FIG. 3, the energy maximizing algorithm considers the energy production for a given time period for a particular PV structure connected in a total-cross-tied connection. For example, for a m×n total-cross-tied structure where m is the number of rows and n is the number of columns, the partial shading loss reduction engine provides a connection matrix for a PV structure that maximizes energy production for the time period under one or more partial shading situations.

The time period may, for example, comprise a plurality of time durations t_{g} each having a corresponding partial shading situation. The maximization of energy production can therefore be formulated by:

$$Maximize {E}_{A} = {\sum }_{g = 1}^{N} {V}_{Ag} {I}_{Ag} {t}_{g} , \qquad ( 1 )$$

where E_{A} is array total energy, g is the time segment index, N is the number of time segments, V_{AG} is the array total voltage at time segment g, I_{AG} is the array current at time segment g, and tg is the time duration of time segment g.

The partial shading loss reduction engine considers a number of circuit constraints for providing the connection matrix. These include Kirchhoff's Current Law and Kirchhoff's Voltage Law at each time segment, which can be formulated as follows:

$${I}_{Ag} = {\sum }_{j = 1}^{n} {\sum }_{q = 1}^{mn} {I}_{Mqg} {y}_{ijq} ∀ i , g , \qquad ( 2 )$$

where i is the row index, j is the column index, q is the element index, n is the number of columns, m is the number of rows, I_{Mqg} is the element q current at time segment g, and y_{ijq} is a binary variable taking the value 1 when element q is at position (i, j) and 0 otherwise;

$${V}_{Rig} = {\sum }_{q = 1}^{mn} {V}_{Mqg} {y}_{ijq} ∀ i , j , q , \qquad ( 3 )$$

where V_{Rig} is the row i voltage at time segment g and V_{Mqg} is the element q voltage at time segment g; and

$${V}_{Ag} = {\sum }_{i = 1}^{m} {V}_{Rig} ∀ g . \qquad ( 4 )$$

The I-V characteristics for each reconfigurable PV element at each time segment can be described by:

$${IRR}_{qg} \frac{{I}_{SC}}{G} - {I}_{o} ( {e}^{\frac{\frac{{V}_{Mqg}}{{N}_{S}} + {R}_{S} {I}_{Mqg}}{{V}_{T}}} - 1 ) - \frac{\frac{{V}_{Mqg}}{{N}_{S}} + {R}_{S} {I}_{. Mqg}}{{R}_{p}} - I {}_{Mqg} = 0 ∀ q , g , \qquad ( 5 )$$

where IRR_{qg} is the element q irradiance level at time segment g, G is a reference irradiance level, I_{sc} is the element short circuit Current at the reference irradiance level G, Iₒ is the reverse bias diode saturation current, Nₛ is the number of series cells in the element (which may be 1 if the element is a cell, or more than one if the element is a module), Rₛ is the element series resistance, V_{T} is the element thermal voltage, Rₚ is the element parallel resistance.

Other formulas to describe I-V characteristics of the elements could also be used.

The partial shading loss reduction engine also considers logical constraints, including:

$$\begin{matrix}{\sum }_{i = 1}^{m} {\sum }_{j = 1}^{n} {y}_{ijq} = 1 ∀ q , g ; and & ( 6 ) \\ {\sum }_{q = 1}^{mn} {y}_{ijq} = 1 ∀ i , j , g , & ( 7 )\end{matrix}$$

which ensure that each PV element is used once and only once in the PV structure and that each position in the PV structure has one and only one PV element.

By determining the structure total energy for each possible configuration of PV elements in the PV structure, the partial shading loss reduction engine can therefore determine a connection matrix that maximizes the structure total energy over all time segments and reduces partial shading loss.

The partial shading loss reduction engine can also implement a mismatch reduction algorithm. The mismatch reduction algorithm can determine a mismatch index (MI) that may correspond to the sum of the squares of differences between each row's total irradiance levels, which can be formulated as follows:

$${M I}_{g} = 0.5 \times {\sum }_{i = 1}^{m} {\sum }_{l = 1}^{m} {[ {\sum }_{q = 1}^{mn} \frac{{IRR}_{qg} {y}_{iq}}{G} - {\sum }_{q = 1}^{mn} \frac{{IRR}_{qg} {y}_{lq}}{G} ]}^{2} , \qquad ( 8 )$$

where MI_{g} is the mismatch index at time segment g, l is the row index, y_{iq} is a binary variable taking the value 1 when element q is at row i and 0 otherwise, and y_{lq} is a binary variable taking the value 1 when element q is at row l and 0 otherwise. A smaller MI represents a more uniform irradiance level distribution among the rows, which reduces partial shading loss.

Thus, the partial shading loss reduction engine can determine a connection matrix that minimizes the overall mismatch for different partial shading situations, which can be formulated as:

$$Minimize {\sum }_{g = 1}^{N} {MI}_{g} * {t}_{g} . \qquad ( 9 )$$

The partial shading loss reduction engine is subject to a number of constraints in providing the connection matrix, including:

$$\begin{matrix}{\sum }_{i = 1}^{m} {y}_{iq} = 1 ∀ q , g ; and & ( 10 ) \\ {\sum }_{q = 1}^{mn} {y}_{iq} = n ∀ i , g . & ( 11 )\end{matrix}$$

These constraints ensure that all the reconfigurable PV elements are used and that each row has exactly n elements respectively. Alternatively, the PV structure may comprise rows having unequal numbers of elements if the constraint of equation (11) is relaxed. Also, the constraint of equation (11) can be changed as in equation (12) to limit the number of elements per row to be less than or equal to a certain number nₘₐₓ.

$${\sum }_{q = 1}^{mn} {y}_{iq} \leq {n}_{max} ∀ i , g \qquad ( 12 )$$

The mismatch reduction algorithm has fewer variables and constraints than the energy maximizing algorithm, and it does not require any prior knowledge of the PV structure parameters. By determining the mismatch in the PV structure for each possible configuration of PV elements in the PV structure, the partial shading loss reduction engine can therefore determine a connection matrix that minimizes mismatch and reduces partial shading loss.

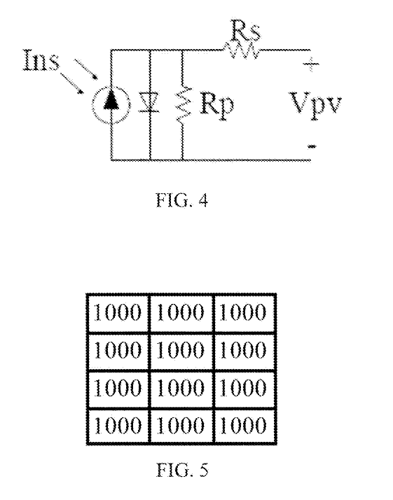

Referring now to FIG. 4, the partial shading loss reduction achievable by the partial shading loss reduction engine can be verified by modelling a PV structure and providing examples of partial shading for the PV structure. An example PV structure may comprise a plurality of PV cells, each modelled by a single diode equivalent circuit as shown, where Ins refers to insolation. Correspondingly, PV modules can be modelled by the connection of a plurality of PV cells, PV arrays and farms can be modelled by the connection of a plurality of PV modules, etc.

The reduction in partial shading loss can be observed by modelling the PV structure as, for example, a 4×3 array of PV cells and connecting the array in each of series-parallel connection (SP), total-cross-tied connection (TCT) and the connection determined by the partial shading loss reduction engine (referred to herein for simplicity as optimal total-cross-tied or OTCT). A comparison can be made for these PV structures of array maximum power point (MPP), modules' generated powers at array's MPP, array's P-V characteristics, Performance Ratio (PR) and MI. PR gives an indication about the amount of mismatch losses in the array.

Referring now to FIG. 5, a first example is a benchmark comparing SP, TCT and OTCT at no partial shading, where the numbers indicate irradiance levels of the PV elements at their physical locations in W/m².

Referring now to Table 1 and FIG. 6, the PR is unity for both arrays and both are working at their MPPs. Also, all the modules are working at their MPPs. The MPP for the array is 1,020 W and for the module is 85 W. It an therefore be seen that under no partial shading, a PV structure having OTCT connections operates equally well as that having SP and TCT connections.

TABLE 1

| | Modules' powers | | | | | | Power change |
|---|---|---|---|---|---|---|---|
| | at Array MPP | | | Array MPP | | | w.r.t SP |
| | (W) | | | (W) | PR | MI | (%) |
| SP, | 85 | 85 | 85 | 1020 | 1.00 | 0.00 | — |
| TCT & | 85 | 85 | 85 | | | | |
| OTCT | 85 | 85 | 85 | | | | |
| | 85 | 85 | 85 | | | | |

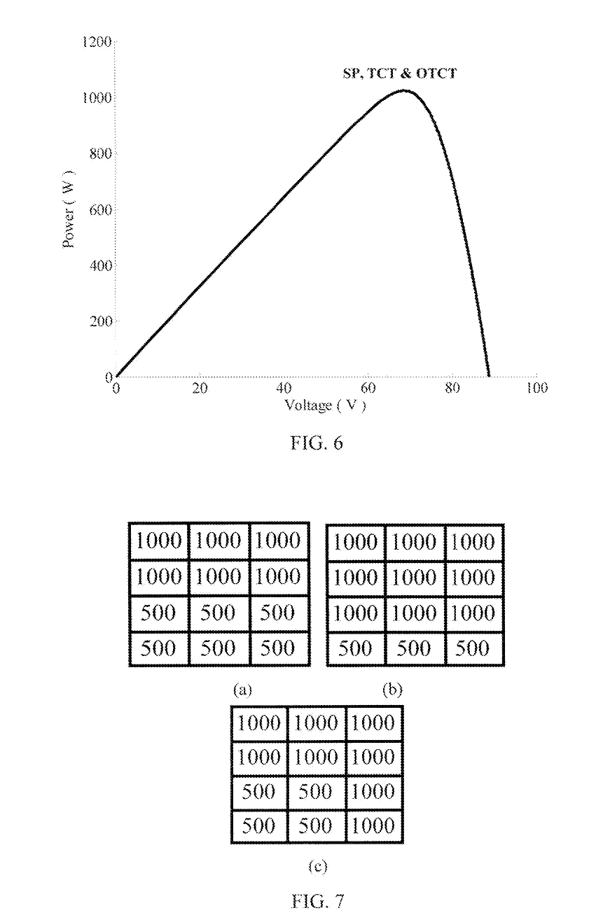

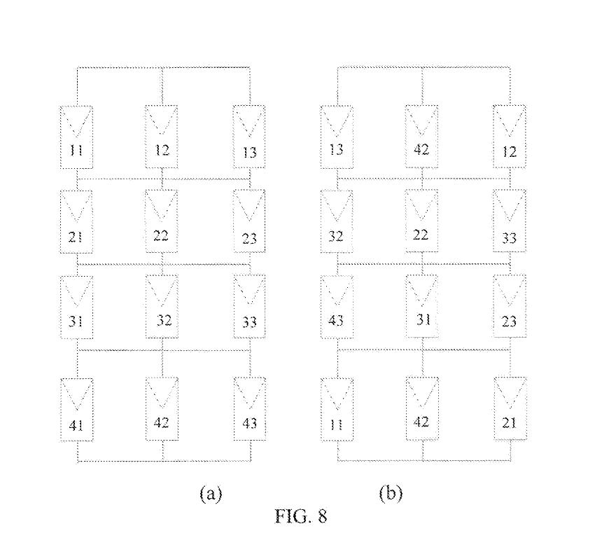

Referring now to FIG. 7, a second example shows a partial shading during three time segments of equal duration. Referring to FIG. 8a, TCT connection is shown for PV elements referred to by a reference numeral that is its row number followed by column number and in FIG. 8b, a connection matrix provided by OTCT is shown for PV elements referred to by the same reference numeral.

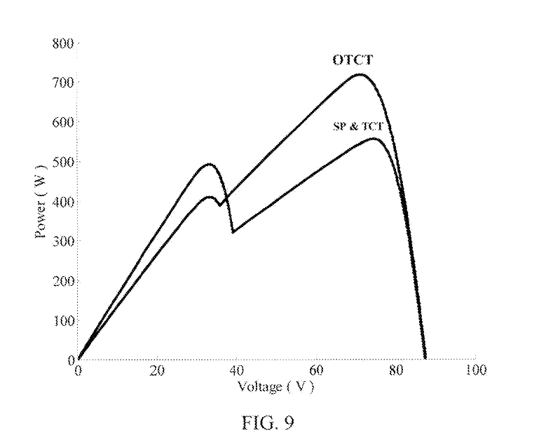

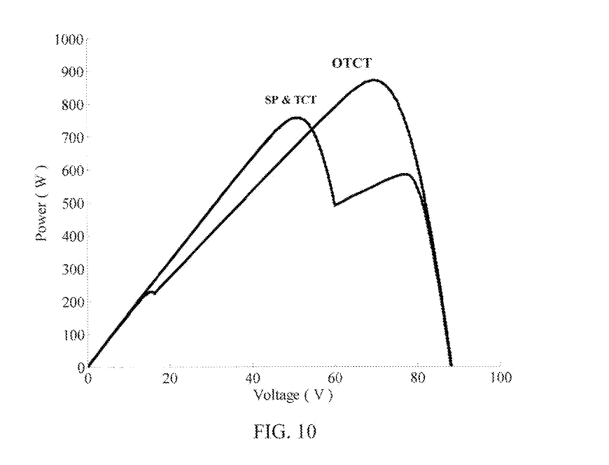

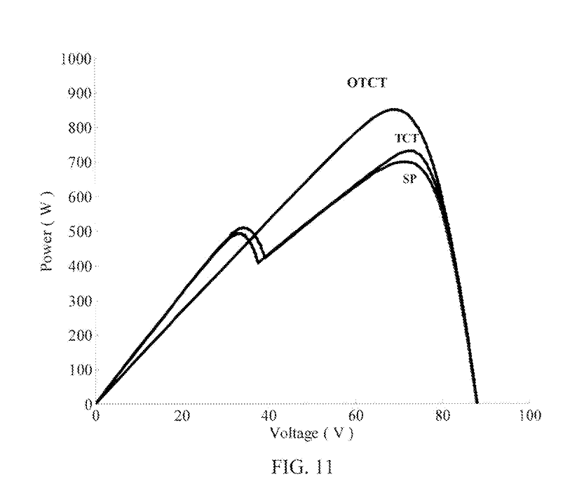

Referring to Table 2 and FIG. 9, a comparison is shown between SP, TCT and OTCT under the partial shading condition of the first time segment. Table 3 and FIG. 10 show a comparison between SP, TCT and OTCT under the partial shading condition of the second time segment. Table 4 and FIG. 11 show a comparison between SP, TCT and OTCT under the partial shading condition of the third time segment.

TABLE 2

| | | | | | | | Power change |
|---|---|---|---|---|---|---|---|
| | Modules' | | | Array MPP | | | w.r.t SP |
| | powers (W) | | | (W) | PR | MI | (%) |
| SP & | 51 | 51 | 51 | 555 | 0.73 | 6 | — |
| TCT | 51 | 51 | 51 | | | | |
| | 41 | 41 | 41 | | | | |
| | 41 | 41 | 41 | | | | |
| OTCT | 76 | 76 | 76 | 717 | 0.937 | 2 | 29.2 |
| | 76 | 84 | 84 | | | | |
| | 41 | 41 | 41 | | | | |
| | 41 | 41 | 41 | | | | |

TABLE 3

| | | | | | | | Power change |
|---|---|---|---|---|---|---|---|
| | Modules' | | | Array MPP | | | w.r.t SP |
| | powers (W) | | | (W) | PR | MI | (%) |
| SP & | 85 | 85 | 85 | 757 | 0.848 | 4.5 | — |
| TCT | 85 | 85 | 85 | | | | |
| | 85 | 85 | 85 | | | | |
| | −3.1 | −3.1 | −3.1 | | | | |
| OTCT | 85 | 85 | 85 | 870 | 0.975 | 0.5 | 14.9 |
| | 85 | 78 | 85 | | | | |
| | 85 | 78 | 78 | | | | |
| | 42 | 42 | 42 | | | | |

TABLE 4

| | | | | | | | Power change |
|---|---|---|---|---|---|---|---|
| | Modules' | | | Array MPP | | | w.r.t SP |
| | powers (W) | | | (W) | PR | MI | (%) |
| SP | 52 | 52 | 84.3 | 700 | 0.824 | — | — |
| | 52 | 52 | 84.3 | | | | |
| | 38.7 | 38.7 | 84.3 | | | | |
| | 38.7 | 38.7 | 84.3 | | | | |
| TCT | 66.3 | 66.3 | 66.3 | 731 | 0.86 | 4 | 4.4 |
| | 66.3 | 66.3 | 66.3 | | | | |
| | 41.3 | 41.3 | 84 | | | | |
| | 41.3 | 41.3 | 84 | | | | |
| OTCT | 85 | 85 | 85 | 850 | 1.00 | 0 | 21.4 |
| | 85 | 85 | 85 | | | | |
| | 42.2 | 42.2 | 85 | | | | |
| | 42.2 | 42.2 | 85 | | | | |

It can be seen that a PV structure having OTCT connections operates with less partial shading loss than that having SP and TCT connections.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

What is claimed is:

1. A system for reducing mismatch in a photovoltaic structure, said photovoltaic structure comprising a plurality of photovoltaic elements arranged in a plurality of rows and a plurality of columns, said system characterized by a partial shading loss reduction engine operable to provide a connection matrix for said photovoltaic structure based on irradiance levels for said photovoltaic elements, said connection matrix enabling connection of said photovoltaic elements to one another in a plurality of parallel circuits connected together to reduce mismatch for a plurality of time instants.

2. The system of claim 1, characterized in that said partial shading loss reduction engine generates a mismatch index based on said irradiance levels and provides the connection matrix based on minimizing said mismatch index.

3. The system of claim 1, characterized in that said partial shading loss reduction engine provides the connection matrix based on increasing energy production of said photovoltaic structure for said plurality of time instants.

4. The system of claim 1, characterized in that said connection matrix enables at least two of said photovoltaic elements from one of said rows to be connected in different parallel circuits.

5. The system of claim 4, characterized in that said at least two photovoltaic elements are adjacent photovoltaic elements.

6. The system of claim 1, further characterized by an input utility for providing said irradiance levels.

7. The system of claim 6, characterized in that said input utility enables a user to provide observed irradiance levels for said photovoltaic elements at an installation site.

8. The system of claim 7, characterized in that said connection matrix enables connection of said parallel circuits to one another in series.

9. The system of claim 1, characterized in that said connection matrix enables at least two of said parallel circuits to comprise unequal numbers of said photovoltaic elements.

10. A method for reducing mismatch in a photovoltaic structure, said photovoltaic structure comprising a plurality of photovoltaic elements arranged in a plurality of rows and a plurality of columns, said method characterized by providing a connection matrix for said photovoltaic structure based on irradiance levels for said photovoltaic elements, said connection matrix enabling connection of said photovoltaic elements to one another in a plurality of parallel circuits connected together to reduce mismatch for a plurality of time instants.

11. The method of claim 10, characterized by the further steps of generating a mismatch index based on said irradiance levels and determining a minimum mismatch index, wherein said connection matrix is based on said minimum mismatch index.

12. The method of claim 10, characterized by the further step of increasing energy production of said photovoltaic structure for said plurality of time instants and determining a maximum energy production, wherein said connection matrix is based on said maximum energy production.

13. The method of claim 10, characterized in that said connection matrix enables at least two of said photovoltaic elements from one of said rows to be connected in different parallel circuits.

14. The method of claim 13, characterized in that said at least two photovoltaic elements are adjacent photovoltaic elements.

15. The method of claim 10, further characterized by providing said irradiance levels.

16. The method of claim 15, characterized in that a user provides said irradiance levels, said irradiance levels being observed irradiance levels for said photovoltaic elements at an installation site.

17. The method of claim 15, characterized in that said irradiance levels are historical observed irradiance levels for said photovoltaic elements at an installation site.

18. The method of claim 10, characterized in that said connection matrix enables connection of said parallel circuits to one another in series.

19. The method of claim 10, characterized in that said connection matrix enables at least two of said parallel circuits to comprise unequal numbers of said photovoltaic elements.
